(19) United States
(12) Patent Application Publication
(10) Pub. No.: US 2008/0178152 A1
(43) Pub. Date: Jul. 24, 2008

(54) Software Code Retention Management

(76) Inventors: Rafal Przemyslaw Konik, Oronoco, MN (US); Mark William Theuer, Rochester, MN (US); Michael Alan Venz, Rochester, MN (US)

Correspondence Address: IBM CORPORATION, 3605 HIGHWAY 52 NORTH, DEPT 917, ROCHESTER, MN, 55901-7829, US

(21) Appl. No.: 11/625,880

(22) Filed: Jan. 23, 2007

(51) Int. Cl. G06F 9/44

(52) U.S. Cl. 717/120

(57) ABSTRACT

A method, system and computer-readable medium for creating and using perishable code are presented. In a preferred embodiment, the method includes the steps of determining if a unit of code is perishable; and in response to determining that the unit of code is perishable, disabling the unit of code, either by deleting the unit of code or by disabling it.

### BACKGROUND OF THE INVENTION

1. Technical Field

The present technical field relates in general to the field of data processing, and, in particular, to software. Still more particularly, the present technical field relates to the creation and use of perishable software code.

2. Description of the Related Art

From a high-level perspective, a computer can be viewed as a collection of hardware that, under the control of an operating system, executes programs to manipulate data (including values, images, etc.). During the development of such programs, programmers often include lines of code that have only temporary benefit and purpose. For example, during debugging operations of a program, a software developer may add a “try” statement, and alteration, etc., which is to be used only during these debugging operations. After debugging has been completed, such lines of code are no longer needed, and may in fact be detrimental to the final functionality of the program. Thus, this type of code is only needed for a short period of time, such that later it should either be disabled or deleted from the program.

### SUMMARY OF THE INVENTION

To address the problem described above, presented herein are a method, system and computer-readable medium for utilizing perishable code. In one embodiment, the method includes the steps of determining if a unit of code is perishable; and in response to determining that the unit of code is perishable, disabling the unit of code.

The above, as well as additional purposes, features and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a high-level flow chart of exemplary steps taken to create perishable software code;

FIG. 2 is a high-level flow chart of exemplary steps taken to evaluate whether particular software code is perishable; and

FIG. 3 illustrates an exemplary computer in which the present invention may be utilized.

### DETAILED DESCRIPTION OF THE PREFERRED EMBODIMENT

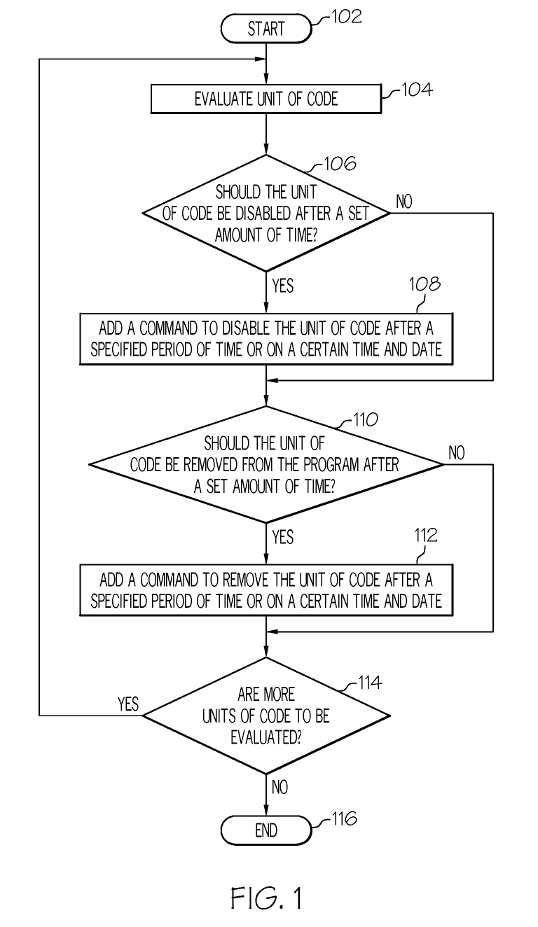

With reference now to the figures, and particularly to FIG. 1, there is a flow-chart of exemplary steps taken to create perishable code. For purposes of the present disclosure, perishable code is defined as software code that is designed to have a limited lifetime, after which it is to be disabled and/or deleted. After initiator block 102, which may be prompted by a decision to make some or all units of code in a program perishable, a next unit of code in a program is evaluated to determine if it should be perishable (block 104). For purposes of the present disclosure, a unit of code is defined as an object, a subroutine, a macro, a single line of code, an applet, or any other unit or subunit of software instructions. Initially, this unit of code is in a standard format, meaning that there are no limitations on the lifetime of the code. However, a programmer may intend for this unit of code to function for only a limited amount of time. While a primary need for code to be perishable (have a limited lifetime) comes from debugging and other test operations, it may be desired for other code to also be perishable, including code that adds time sensitive features to an application, security code that needs to “self destruct” after a specific amount of time, etc.

If it is determined that the unit of code should be disabled after a certain amount of time (query block 106), then a command, which disables the unit of code after this certain amount of time, is inserted within or near that unit of code. This command makes the unit of code expire at a certain time, date, and/or after a particular period of time, and/or after a particular number of executions, et al. (block 108). That is, a command may be added to disable the unit of code at a particular time, date, time of day, etc., or the unit of code may be disabled after a particular amount of time passes since the unit of code was added to the program, or the code may be disabled after being executed a predetermined number of times. These “triggers” for disabling the unit of code are exemplary in nature, and are not to be construed as limiting the scope of the present invention.

Consider now an exemplary format for a command that makes a unit of code perishable, whether that perishable nature is caused by the unit of code being disabled or removed:

| Parameter 1 | Parameter 2 | Parameter 3 | Parameter 4 |
|---|---|---|---|
| Code name | ISO format | DISABLE\|REMOVE | MSG\|NO MSG |

“Parameter 1” is the name of the command (keyword name of the command that makes the unit of code perishable). “Parameter 2” describes what date format is to be used to describe when the unit of code should be disabled (or removed). In the example shown, the International Standards Organization (ISO) format is to be used. “Parameter 3” describes whether the unit of code should simply be disabled at a particular point in time, or if it should be deleted from the program. “Parameter 4” describes whether a message should be sent when the unit of code is disabled or removed. Thus, utilizing the format shown above, an exemplary command language pseudocode may be:

### Perishable (2006-09-30, *REMOVE, *MSG)

wherein “Perishable” is the command name; the expiration date is Sep. 30, 2006 (in ISO format); the code is to be completely removed after that date; and a message is to be sent (e.g., to an administrator) upon removal of the unit of code that is under the control of the command “Perishable.”

As described in blocks 106 and 108, a command may be added to make the unit of code perishable by adding a command that simply disables the unit of code after a set amount of time. However, it may be desired that the unit of code be entirely deleted from the program (query block 110). If so, then a command line for deleting the unit of code at some set time, frequency, etc. is entered (block 112) within or at a control point for the unit of code. The process is reiterated for other units of code in a program (query block 114) until all units of code in the program have either been made perishable or left in their original non-perishable state. The process thus ends at terminator block 116.

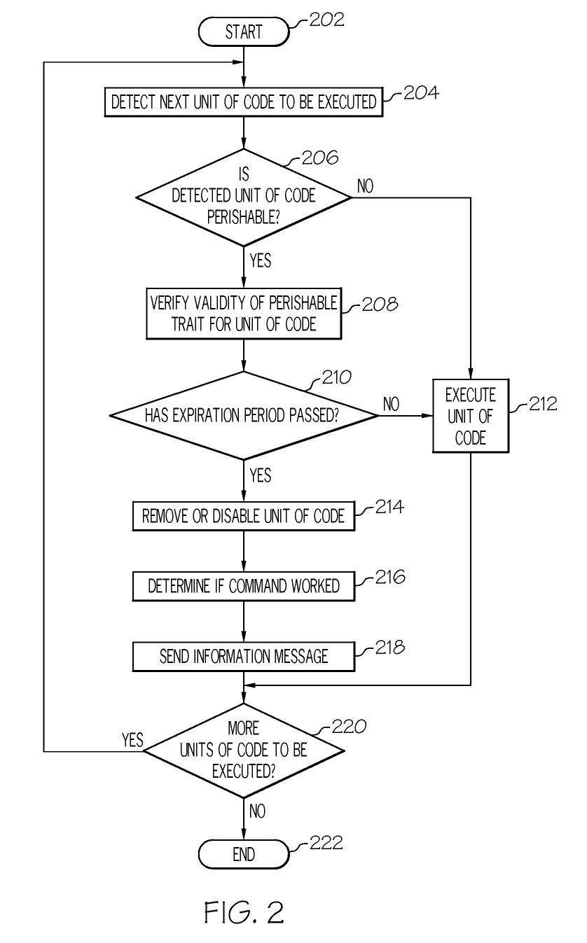

Once the program has been modified to include perishable features of one or more units of code, the program may be run. Referring now to FIG. 2, a flow-chart of exemplary steps in how such perishable features may be utilized is shown. After initiator block 202, which may be the running, compiling, execution, debugging, etc. of a program or interpreter, a next unit (e.g., line, block, subroutine, object, etc.) of code is detected (block 204 for execution (e.g., compiling, testing, etc.). If no command is detected that makes the unit of code perishable (query block 206), then the unit of code is executed normally. However, if a command that makes the unit of code perishable is detected (query block 206), then a verification is made to ensure that the command is valid (block 208). That is, a message may be sent to an administrator to ensure that the command to remove/disable the code is NOT a virus or other malicious code. Alternatively, the command can be screened by an anti-virus program. In yet another alternative embodiment, the command can be compared with a list of trusted commands created by the programmer. Preferably, these trusted commands have a unique feature (e.g., a unique string of non-functional characters) that identify them as being created by the programmer or another trusted entity.

Once the command is confirmed as being valid, a determination is made as to whether it is time for the controlled unit of code to be disabled (or removed), as described in query block 210. If the controlled unit of code is to be left alone, then it is executed (block 212). Otherwise, the controlled unit of code is disabled or removed, according to the “disable/remove” parameter set by the command (block 214). A determination can then be made to confirm that the command worked properly (block 216). This determination can be as simple as confirming that the controlled unit of code was removed, or as complex as the programmer desires (e.g., confirming that the controlled code is actually disabled through the use of test inputs; evaluating what effect the removal of the controlled code had on other code/programs; etc.). An information message can then be sent (block 218), informing a control program, human programmer (via a user interface screen), or other entity that the controlled code has or has not been disabled (or totally removed), and/or that the disabling/removing process worked properly without undue ill effects. The process continues in an iterative manner (query block 220) until the entire program has been executed (terminator block 222).

It should be noted that the order and sequence of steps shown in FIG. 1 and FIG. 2 may be altered without adversely affecting the intended process. For example, steps 106/108 and steps 110/112 in FIG. 1 may be switched without adversely affecting the overall process of modifying units of code to become perishable.

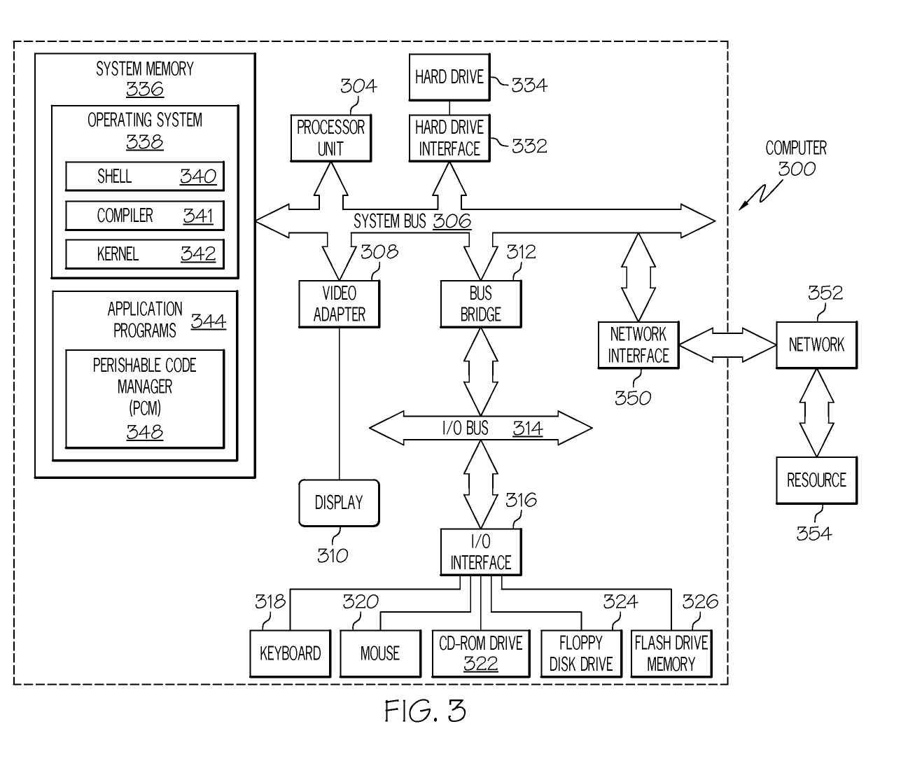

With reference now to FIG. 3, there is depicted a block diagram of an exemplary computer 300, with which the present invention may be utilized. Computer 300 includes a processor unit 304 that is coupled to a system bus 306. A video adapter 308, which drives/supports a display 310, is also coupled to system bus 306. System bus 306 is coupled via a bus bridge 312 to an Input/Output (I/O) bus 314. I/O interface 316 is coupled to I/O bus 314. I/O interface 316 affords communication with various I/O devices, including a keyboard 318, a mouse 320, a Compact Disk-Read Only Memory (CD-ROM) drive 322, a floppy disk drive 324, and a flash drive memory 326. The format of the ports connected to I/O interface 316 may be any known to those skilled in the art of computer architecture, including but not limited to Universal Serial Bus (USB) ports.

A hard drive interface 332 is also coupled to system bus 306. Hard drive interface 332 interfaces with a hard drive 334. In a preferred embodiment, hard drive 334 populates the system memory 336, which is also coupled to system bus 306. System memory is defined as a lowest level of volatile memory in computer 300. This volatile memory may include additional higher levels of volatile memory (not shown), including, but not limited to, cache memory, registers, and buffers. Code that populates system memory 336 includes an operating system (OS) 338 and application programs 344.

OS 338 includes a shell 340, for providing transparent user access to resources such as application programs 344. Generally, shell 340 (as it is called in UNIX®) is a program that provides an interpreter and an interface between the user and the operating system. More specifically, shell 340 executes commands that are entered into a command line user interface. Thus, shell 340, also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., kernel 342) for processing. Note that while shell 340 is a text-based, line-oriented user interface, the present invention will equally well support other user interface modes, such as graphical, voice, gestural, etc.

As depicted, OS 338 also includes kernel 342, which includes lower levels of functionality for OS 338. Kernel 342 provides essential services required by other parts of OS 338 and application programs 344. The services provided by kernel 342 include memory management, process and task management, disk management, and mouse and keyboard management. OS 338 also includes a compiler 341 that is utilized by users of computer 300 to transform high level source code into executable object code. In an alternate embodiment, compiler 341 may be included in application programs 344.

Application programs 344 in system memory 336 include a Perishable Code Manager (PCM) 348. In one embodiment, PCM 348 performs, supervises, and/or manages all or some of the steps illustrated in FIGS. 1-2. Although illustrated as a single component, in some embodiments PCM 348 may be formed of multiple software components.

A network interface 350 is coupled to system bus 306. Network interface 350 allows computer 300 to communicate, via a network 352, to other resources 354, which may be a server, a supervisory computer, a management computer, a database, a web server, etc. If resource 354 is a software deploying server, then PCM 348 can be deployed to computer 300, preferably in an “on demand” basis in which the software is only deployed after computer 300 sends resource 354 a message indicating a need for PCM 348.

The hardware elements depicted in computer 300 are not intended to be exhaustive, but rather represent and/or highlight certain components that may be utilized to practice the present invention. For instance, computer 300 may include alternate memory storage devices such as magnetic cassettes, Digital Versatile Disks (DVDs), Bernoulli cartridges, and the like. These and other variations are intended to be within the spirit and scope of the present invention.

It is understood that the use herein of specific names are for example only and not meant to imply any limitations on the invention. The invention may thus be implemented with different nomenclature/terminology and associated functionality utilized to describe the above devices/utility, etc., without limitation.

As noted above, it is to be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media, including but not limited to tangible computer-readable media, when carrying or encoded with a computer program having computer readable instructions that direct method functions in the present invention, represent alternative embodiments of the present invention. Further, it is understood that the present invention may be implemented by a system having means in the form of hardware, software, or a combination of software and hardware as described herein or their equivalent.

Thus, in one embodiment, the present invention may be implemented through the use of a computer-readable medium encoded with a computer program that, when executed, performs the inventive steps described and claimed herein. Furthermore, the computer program may be deployed to a client computer from a software providing service via an external resource such as a software deploying server. Such software may be provided in an “on demand” basis that is determined by the client computer and/or the client computer's manager.

Thus, presently disclosed herein are a method, system and computer-readable medium for utilizing perishable code. In one embodiment, the method includes the steps of determining if a unit of code is perishable; and in response to determining that the unit of code is perishable, disabling the unit of code. The unit of code may be disabled by deleting the unit of code from an interpretable source, such as a program, an applet, a HyperText Markup Language (HTML) file, etc. The method may further include the step of validating a command, which is used to disable the unit of code, before disabling the unit of code, wherein the command is automatically validated by a computer by comparing the command with a trusted list of commands, or alternatively, the command is manually validated by an administrator. The method may further include the step of transmitting a message to an administrator when the unit of code is disabled. Furthermore, the method may include the steps of determining if the disabling of the unit of code impacted on other code; and in response to determining that the disabling of the unit of code caused an impact on other code, transmitting an information message describing the impact.

While the invention has been particularly shown and described with reference to a preferred embodiment, it will be understood by those skilled in the art that various changes in form and detail may be made therein without departing from the spirit and scope of the invention.

What is claimed is:

1. A method comprising:
determining if a unit of code is perishable; and
in response to determining that the unit of code is perishable, disabling the unit of code.

2. The method of claim 1, wherein the unit of code is disabled by deleting the unit of code from an interpretable source.

3. The method of claim 2, wherein the unit of code is deleted under a control of a delete command, and wherein the method further comprises:
deleting the delete command when the unit of code is deleted.

4. The method of claim 1, further comprising:
validating a command, which is used to disable the unit of code, before disabling the unit of code.

5. The method of claim 4, wherein the command is automatically validated by a computer by comparing the command with a trusted list of commands.

6. The method of claim of claim 1, further comprising:
transmitting a message to an administrator when the unit of code is disabled.

7. The method of claim 1, further comprising:
determining if the disabling of the unit of code caused an impact on other code; and
in response to determining that the disabling of the unit of code caused an impact on other code, transmitting an information message describing the impact.

8. A system comprising:
a processor;
a data bus coupled to the processor;
a memory coupled to the data bus; and
a computer-usable medium embodying computer program code, the computer program code comprising instructions executable by the processor and configured for:
determining if a unit of code is perishable; and
in response to determining that the unit of code is perishable, disabling the unit of code.

9. The system of claim 8, wherein the unit of code is disabled by deleting the unit of code from an interpretable source.

10. The system of claim 8, wherein the instructions are further configured for:
validating a command, which is used to disable the unit of code, before disabling the unit of code.

11. The system of claim 10, wherein the command is automatically validated by a computer by comparing the command with a trusted list of commands.

12. The system of claim 10, wherein the command is manually validated by an administrator.

13. The system of claim 8, wherein the instructions are further configured for:
transmitting a message to an administrator when the unit of code is disabled.

14. The system of claim 8, wherein the instructions are further configured for:
determining if the disabling of the unit of code impacted on other code; and
in response to determining that the disabling of the unit of code caused an impact on other code, transmitting an information message describing the impact.

15. A computer-readable medium embodying computer program code for managing software code retention, the computer program code comprising computer executable instructions configured for:
determining if a unit of code is perishable; and
in response to determining that the unit of code is perishable, disabling the unit of code.

16. The computer-readable medium of claim 15, wherein the unit of code is disabled by deleting the unit of code from an interpretable source.

17. The computer-readable medium of claim 15, wherein the computer executable instructions are further configured for:
validating a command, which is used to disable the unit of code, before disabling the unit of code.

18. The computer-readable medium of claim 17, wherein the command is automatically validated by a computer by comparing the command with a trusted list of commands.

19. The computer-readable medium of claim 17, wherein the command is manually validated by an administrator.

20. The computer-readable medium of claim 15, wherein the computer executable instructions are further configured for:
determining if the disabling of the unit of code impacted on other code; and
in response to determining that the disabling of the unit of code caused an impact on other code, transmitting an information message describing the impact.
